(19) United States
(12) Patent Application Publication
(10) Pub. No.: US 2005/0135766 A1
(43) Pub. Date: Jun. 23, 2005

(54) Hex tube light homogenizer system and method

(75) Inventors: Frank Cianciotto, Queen Creek, AZ (US); George H. Butler III, Mesa, AZ (US)

Correspondence Address: SENNIGER POWERS LEAVITT AND ROEDEL, ONE METROPOLITAN SQUARE, 16TH FLOOR, ST LOUIS, MO, 63102, US

(73) Assignee: The Boeing Company

(21) Appl. No.: 10/744,922

(22) Filed: Dec. 23, 2003

(51) Int. Cl. G02B 6/00

(52) U.S. Cl. 385/133

(57) ABSTRACT

A light homogenizer having a hexagonal cross-section tube concentric about a longitudinal axis within an internal highly light reflective metallic surface and a first end of the tube for receiving a non-homogenous light from a light source and a second end of the tube for exiting of homogenized light. The tube preferably has an internal surface formed of a metallic layer of gold or silver and an external support member preferably formed of nickel or other equivalent material. A method is provided in which the hexagonal tube is formed on an aluminum mandrel which is then chemically dissolved to separate the mandrel from the internal highly light reflective metallic surface.

### FIELD OF THE INVENTION

The present invention relates to the field of light transmitting systems, and more particularly, to systems which modify the spacial profile of light being transmitted.

### BACKGROUND OF THE INVENTION

There are many systems in various industries which require a light beam which is fairly homogenous across the span of the beam of light. Most light sources, however, produce non-homogenous light emanating from the source. However, it is possible with the use of light filtering or correcting devices to produce homogenous light which can then be used in light transmission and other systems.

Light transmitted through a fiber, for example, generally has a Gaussian distribution of light intensity as it is emitted from the end of the fiber with higher intensity levels in the center of the fiber and decreasing levels extending toward the edges of the fiber diameter. Such a light intensity profile is less desirable than a uniform profile across the output end of the fiber for use in optical related equipment and light transmission devices.

In the past, it has been common to utilize a solid glass hexagonal rod of various designs to “homogenize” the light coming from the end of a fiber to produce a substantially uniform light output from the device. Since such glass rods are fragile (and require a coating be placed on the exterior side surfaces of the rod), such systems for homogenizing light sources are fragile and do not lend themselves for use in a rugged environment in which they might be easily damaged or broken. In addition, such glass rods are relatively heavy and fairly expensive to produce.

Therefore, it would be advantageous to have a system for homogenizing light that is more rugged than glass rods, cheaper to produce and of relatively light weight.

### SUMMARY OF THE INVENTION

The present invention overcomes the above-described deficiencies and disadvantages of prior systems by providing a light homogenizing system which can change the light intensity output from a Gaussian profile to a “top hat” profile which is essentially uniform across the output end of the light homogenizer member. The present system is of relatively light weight, much more durable than the glass rods and is of relatively low cost and easy to manufacture.

In an embodiment of the present invention, the light homogenizer has a hexagonal cross section tube concentric about a longitudinal axis with an internal highly light reflective surface with a first open end of the tube for receiving a non-homogenous light from a light source and a second open end of the tube for exiting of the homogenized light.

In one aspect of the present invention, the internal highly light reflective surface is preferably provided by a layer of a relatively thin metallic coating supported by an external support member. The external support member is preferably a relatively thick metallic coating which can support the internal metallic layer and maintain the hexagonal cross-sectional shape of the tube during use. The internal highly light reflective coating is preferably made of gold or silver while the support member is preferably made of nickel or other equivalent material.

In another aspect of the present invention, a method of homogenizing light is provided in which a light source is used to provide a focused light beam of non-homogenous light and a light homogenizer tube is disposed for receiving light from the light source, the tube having a hexagonal cross-section concentric about a longitudinal axis with an internal highly light reflective surface and having a first open end for receiving non-homogenous light from the light source and a second open end for exiting of the homogenized light. In this system, the light homogenizer is essentially that described above.

In a further aspect of the present invention, a method of fabricating a light homogenizer is provided in which a mandrel is provided having a hexagonal cross-section and a longitudinally extending outer surface. A first metallic layer is formed on the mandrel conforming to the outer hexagonal surface of the mandrel and is so formed on the mandrel as to have a highly light reflective metallic surface engaging the mandrel. The mandrel is then separated from the metallic layer so that the first metallic layer forms a hexagonal cross-section tube with longitudinal axis and being capable of receiving non-homogenous light from a light source disposed at a first open end and transverse to the longitudinal axis of the tube and homogenizing the light from the light source which exits at a second open end transverse to the longitudinal axis of the tube opposite the first end. The method also preferably includes applying a second metallic layer on top of the first metallic layer before separating the first metallic layer from the mandrel. As above, the first metallic layer is preferably made of gold or silver and the second metallic layer of nickel or other equivalent material. In a preferred method, the mandrel is made of aluminum. After the first and second coatings are formed on the mandrel the aluminum mandrel can be removed by dissolving the mandrel in a solvent that will not dissolve the first and second metallic layers.

### BRIEF DESCRIPTION OF THE DRAWINGS

Having thus described the invention in general terms, reference will now be made to the accompanying drawings wherein:

FIG. 1a is a side view of a preferred embodiment of the system of the present invention showing a light source and a preferred embodiment of an homogenizer tube;

FIG. 1b is a side view of a preferred embodiment of the system of the present invention showing a light source as a “Gaussian” profile and the light output as a “top hat” profile;

FIG. 2 is a cross-sectional view of a mandrel with multiple layers of metallic coating thereon;

FIG. 3 shows an example of a Gaussian distribution profile from a light source such as that of FIG. 1; and

FIG. 4 illustrates a top hat profile of homogenized light output from the tube of FIG. 1.

Corresponding reference characters indicate corresponding parts throughout the drawings.

### DETAILED DESCRIPTION OF THE PREFERRED EMBODIMENT

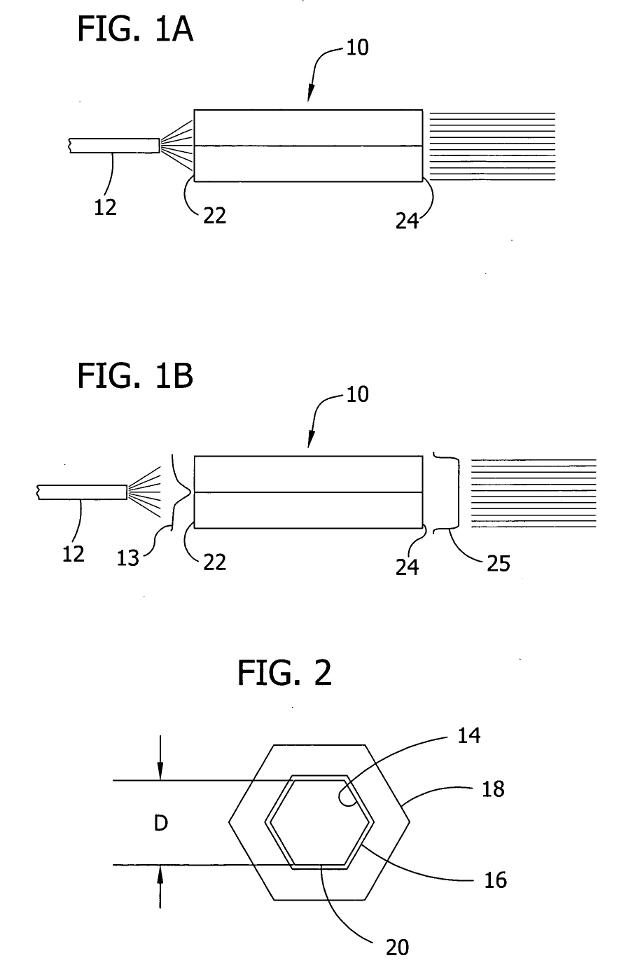

In a preferred embodiment of the present invention as illustrated in FIGS. 1a and 1b, a hexagonal cross-sectional tube shown generally as 10 is provided which receives light internally from a light source 12 such as a single optic fiber. The hexagonal cross-sectional tube 10 is formed within an internal highly reflective surface 14 of hexagonal cross-section, preferably formed of gold or silver which forms a first metallic layer 16 having the reflective surface 14. In order to support the relatively thin metallic layer 16 a second metallic layer 18 is provided. This second metallic layer is preferably formed of nickel since it is cheaper than gold or silver and can provide the needed support structure for the relatively thin first layer 16.

In order to fabricate the hexagonal cross-section tube 10 forming the light homonogenizer, a mandrel 20 is utilized (see FIG. 2). Mandrel 20 is preferably made of aluminum and given a surface finish appropriate to produce the desired reflectivity on the internal surface of the tube, as discussed below. The first metallic layer 16 is applied to the mandrel 20 through any of several known techniques such as electroforming. Electroforming is essentially a process of plating the mandrel 20 with a layer of gold or silver to form the layer 16 and then further plating with a layer of nickel to form the outer support member or second metallic surface 18. The aluminum mandrel 20 is then removed from the interior surface 14 by melting, chemically etching, or exploiting differences in thermal coefficients of expansion between the electroformed parts and the mandrel. For example, in the present case the aluminum mandrel 20 is coated with silver or gold to form the layer 16 and then coated to form the second layer of nickel 18. The aluminum mandrel is then preferably chemically dissolved leaving the nickel hexagonal tube with a highly reflective interior surface of gold or silver. However, other suitable materials may be utilized without departing from the scope of the present invention.

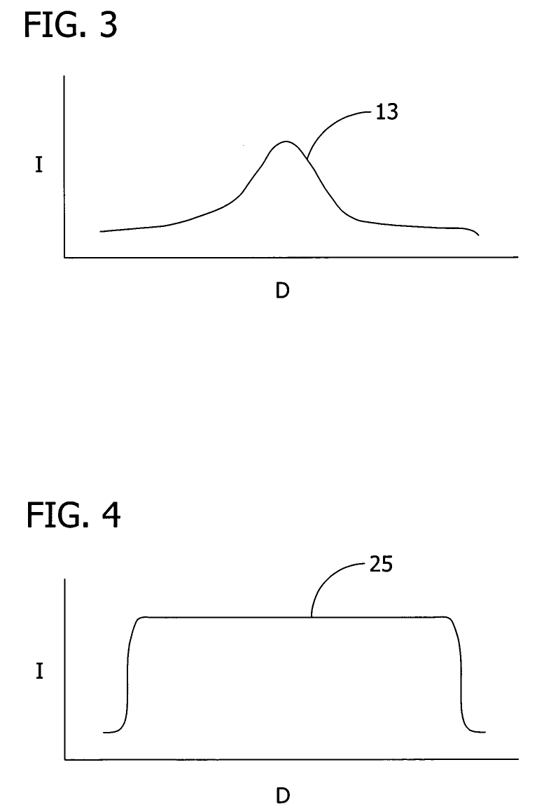

The first layer of metallic coating 16 with the internal highly reflective surface 14 is formed of gold or silver or some other selected material which can maximize the performance of the hexagonal tube for specific light spectrums based on the reflectivity of the material, which selection process is well known to those skilled in the art. By the use of this highly reflective internal surface 14 the hex tube is capable of transforming a single fiber optic light output from the Gaussian shape 13 shown in FIGS. 1b and 3 to the top hat profile 25 shown in FIGS. 1b and 4 as an output from the homogenizer tube 10. In FIGS. 3 and 4 the graph shows an exemplary pattern of light intensity (I) versus the distance (D) across the fiber or from land-to-land in the tube 10 as shown as D in FIG. 2. FIG. 1b pictorially shows the “Gaussian” input and “top hat” (homogenous) output.

FIG. 3 is exemplary of the light intensity from a single optic fiber output where the light intensity profile varies across the diameter of the fiber. As shown in FIG. 3 the higher intensity light is in the center of the fiber and decreases near the outer edges of the fiber. When light from the optic fiber 12 enters the end 22 of tube 10 with the profile of FIG. 3 and is reflected from the surfaces of the hexagonal cross-sectional tube 10 it is transformed at the output end 24 of the tube to the top hat pattern of FIG. 4 where the intensity is essentially uniform across the span of the tube from land-to-land. In addition, the relatively small diameter of the light beam coming from a single fiber optic, such as for example, 0.020 inch (0.5 mm) diameter as it exits the optic fiber 12 is transformed in the tube to 0.240 inches (6 mm) from land-to-land at the exit end 24 of tube 10. To achieve this example, a hexagonal tube 10 having an internal light reflective surface having an internal transverse dimension of 0.254 inch (6.35 mm) from flat to opposite flat and a length of 1.016 inch (25.4 mm) was utilized.

The internal length to width (flat-to-flat) dimensions of tube 10 are preferably such that the length is approximately four to five times the internal width of tube 10. This length to width ratio is preferable since a smaller ratio may not allow enough “bounce” of the light to adequately homogenize it before it exits the tube and a substantially larger ratio would allow too much “bounce” of the light which would reduce the energy level of the light at the output of the tube 10. However, other ratios may be used without departing from the scope of the invention.

The surface smoothness of the highly light reflective internal surface 14 can vary substantially depending upon the purpose for which the present system is being utilized. However, in a preferred embodiment where the internal highly light reflective surface is silver the optical smoothness of the surface is preferably in the range of λ/2 to λ/6 and more preferably about λ/4. This is particularly useful where the wave length of the light from the light source is in the visible to near infrared range of approximately 400 to 780 nanometers. This same surface smoothness range is also appropriate for establishing the highly light reflective surface for many uses of the present invention so long as the reflectivity of the surface is at least 99 percent. It is envisioned that other optical smoothness and surface reflectivity could be used in the present invention.

The thickness of the internal layer of reflective material can vary as desired so long as it is adequately thick to provide the highly light reflective surface described above. The tube 10 could be formed of a single material so long as it is thick enough to be self supporting. However, for cost reasons, the thickness of the first layer 16, particularly when formed of gold or silver should be relatively thin, for example about 0.0001 to 0.0002 inches thick, and the second layer 18 should be relatively thick, for example about 0.010 to 0.020 inches thick. Thicknesses different from the forgoing examples do not depart from the scope of the invention.

Although the light source 12 has been described as an optic fiber, any light source could be usable with the present invention. It is also contemplated that the light source could be positioned at least partially inside the tube, unlike prior art systems where the glass rod is solid.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above constructions and methods without departing from the scope of the invention, it is intended that all matter contained in the above description and shown in the accompanying drawings shall be interpreted as illustrative and not in a limiting sense.

1. A light homogenizer, comprising:
a hexagonal cross-section tube concentric about a longitudinal axis with an internal highly light reflective surface and having a first end of the tube for receiving a non-homogenous light from a light source and a second end of the tube for exiting of homogenized light.

2. The light homogenizer of claim 1 wherein the internal highly light reflective surface is an internal surface of a relatively thin tubular member supported by an external support member.

3. The light homogenizer of claim 2 wherein the external support member is a tubular member thicker than the relatively thin tubular member.

4. The light homogenizer of claim 1 wherein the length of the tube is about four to five times the distance from one land to an opposite land internally of the tube.

5. The light homogenizer of claim 1 wherein the internal highly light reflective surface is gold or silver.

6. The light homogenizer of claim 3 wherein the internal highly light reflective surface is gold or silver and the external support member is nickel.

7. The light homogenizer of claim 5 wherein the internal highly light reflective surface has an optical smoothness in the range of λ/2 to λ/6.

8. The light homogenizer of claim 1 wherein the internal highly light reflective metallic surface has an optical smoothness of about λ/4.

9. A light homogenizing system, the system comprising:
a light source providing a focused light beam of non-homogenous light;
a light homogenizer tube disposed for receiving light from the light source, the tube having a hexagonal cross-section concentric about a longitudinal axis with an internal highly light reflective surface and having a first end of the tube for receiving non-homogenous light from the light source and a second end of the tube for exiting of homogenized light.

10. The system of claim 9 wherein the internal highly light reflective surface is an internal surface of a relatively thin tubular member supported by an external support member.

11. The system of claim 10 wherein the external support member is a tubular member thicker than the relatively thin tubular member.

12. The system of claim 9 wherein the length of the light homogenizer tube is about four to five times the distance from one land to an opposite land internally of the tube.

13. The system of claim 9 wherein the internal highly light reflective surface of the light homogenizer is gold or silver.

14. The system of claim 11 wherein the internal highly light reflective surface of the light homogenizer is gold or silver and the external support member is nickel.

15. The system of claim 9 wherein the internal highly light reflective surface has an optical smoothness in the range of λ/2 to λ/6.

16. The system of claim 9 wherein the internal highly light reflective surface has an optical smoothness of about λ/4.

17. The system of claim 9 wherein the light source is at least one optical fiber.

18. A method of homogenizing light, the method comprising:
providing a light source for providing a focused light beam of non-homogenous light;
providing a light homogenizer tube disposed for receiving light from the light source, the tube having a hexagonal cross-section concentric about a longitudinal axis with an internal highly light reflective surface and having a first end for receiving non-homogenous light from the light source and a second end for exiting of homogenized light.

19. The method of claim 18 including making the internal highly light reflective surface of the light homogenizer of a relatively thin layer supported by an external support member.

20. The method of claim 19 including making the external support member of the light homogenizer of a relatively thick layer.

21. The method of claim 18 including making the length of the light homogenizer tube about four to five times the distance from one land to an opposite land internally of the tube.

22. The method of claim 18 including making the internal highly light reflective metallic surface of the light homogenizer of gold or silver.

23. The method of claim 20 including making the internal highly light reflective metallic surface of the light homogenizer of gold or silver and the support member of nickel.

24. The method of claim 18 including making the internal surface with an optical smoothness in the range of λ/2 to λ/6.

25. The method of claim 18 including making the internal highly light reflective surface with an optical smoothness of about λ/4.

26. A method of fabricating a light homogenizer, the method comprising:
providing a mandrel of a first material, the mandrel having a hexagonal cross-section and a longitudinally extending outer surface;
forming a first metallic layer on the mandrel conforming to the outer hexagonal surface of the mandrel, the first metallic layer being so formed as to have a highly light reflective metallic surface engaging the mandrel; and
separating the mandrel from the first metallic layer such that the first metallic layer forms a hexagonal cross-section tube having a longitudinal axis and being capable of receiving non-homogenous light from a light source disposed at a first open end transverse to the longitudinal axis of the tube and homogenizing light from the light source which exits a second open end transverse to the longitudinal axis of the tube opposite the first end.

27. The method of claim 26 including applying a second metallic layer on top of the first metallic layer before separating the first metallic layer from the mandrel.

28. The method of claim 26 including forming the first metallic layer of gold or silver.

29. The method of claim 28 including forming the second metallic layer of nickel or equivalent material.

30. The method of claim 29 including forming the mandrel of aluminum.

31. The method of claim 30 wherein the step of separating the mandrel from the first metallic layer includes dissolving the aluminum mandrel in a solvent that does not dissolve the first and second metallic layers.

32. The method of claim 26 including making the highly light reflective metallic surface with an optical smoothness in the range of λ/2 to λ/6.

33. The method of claim 26 including making the internal highly light reflective metallic surface with an optical smoothness of about λ/4.
